(19) United States
(12) Patent Application Publication
(10) Pub. No.: US 2016/0017648 A1
(43) Pub. Date: Jan. 21, 2016

(54) TRUNNION DOOR HINGE

(71) Applicant: HARRYVAN HOLDING B.V., Slochteren (NL)

(72) Inventor: Marcus Cornelis PETRELLI, Slochteren (NL)

(73) Assignee: HARRYVAN HOLDING B.V., Slochteren (NL)

(21) Appl. No.: 14/761,338

(22) PCT Filed: Jan. 16, 2013
(86) PCT No.: PCT/NL2014/050012

§ 371 Date: Jul. 16, 2015

(30) Foreign Application Priority Data
Jan. 16, 2013 (NL) 2010134

(51) Int. Cl. E05D 7/081

(52) U.S. Cl. CPC E05D 7/081

(57) ABSTRACT

A trunnion door hinge having a first hinge part, a second hinge part and a cam mechanism. The cam mechanism has a first cam part, which is nonpivotable relative to the first hinge part, a second cam part, which is nonpivotable relative to the second hinge part, and a first spring element which presses the first cam part and the second cam part towards one another. The cam mechanism further has a third cam part in-between the first cam part and the second cam part. The third cam part at one end interlocks with the first cam part, and at the other end with the second cam part. During the hinging, the third cam part is helically pivotable relative to the first and the second cam part in a first and a second pivot range, respectively.

### FIELD OF THE INVENTION

The invention relates to a trunnion door hinge for hingeably interconnecting a trunnion door and a horizontal boundary, situated near to the door, of the doorway.

### BACKGROUND OF THE INVENTION

Because trunnion door hinges are mounted at the lower side and/or at the upper side of a door, they enable a relatively large hinging range. Doors provided with such hinges are sometimes referred to as trunnion doors. Some trunnion door hinges comprise an, often hydraulic, preferred positions mechanism for pushing the trunnion door in certain preferential hinging positions. This way, a user can easily swing the trunnion door into a number of discrete preferential hinging positions, for example a closed position or open position. In these preferential hinging positions an extra force is needed to move the hinge out of the preferential hinging position, as compared with the force needed to move the hinge in-between two such preferential hinging positions. Once a trunnion door is in such a preferential position, for example an open or closed position of the door, the door cannot unintendedly, for example due to draught, be moved out of that preferential position.

From FIG. 2 of NL 2002119 a trunnion door hinge is known for hingeably interconnecting a trunnion door and a horizontal boundary, situated near to the door, of the doorway. This trunnion door hinge known from FIG. 2 of NL 2002119 comprises a hinge shaft, a first hinge part designed for interconnecting the trunnion door hinge and the horizontal boundary, and a second hinge part designed for interconnecting the trunnion door hinge and a lower side or an upper side of the trunnion door. The second hinge part is hingeable relative to the first hinge part. The trunnion door hinge known from FIG. 2 of NL 2002119 further comprises a cam mechanism by means of which there have been realized multiple preferential hinging positions of the hinge. This cam mechanism comprises a first cam part 11, which is nonpivotable relative to the first hinge part, a second cam part 12 which is nonpivotable relative to the second hinge part, and a spring element 32. The first cam part and the second cam part are separately lying in line along the hinge line. The spring element 32 is pre-tensioned to bias the first cam part and the second cam part towards one another along the hinge line. The first cam part has at its end facing the second cam part a plurality of first cams, and the second cam part has at its end facing the first cam part a plurality of second cams. For the trunnion door hinge known from FIG. 2 of NL 2002119, the preferential hinging positions occur when the first cams of the first cam part under influence of the spring element are being pushed between the second cams of the second cam part in a centered manner.

The trunnion door hinges known from NL 2002119 have a number of drawbacks.

A first drawback is the following. When the trunnion door hinges from one preferential hinging position to the other preferential hinging position, there is a time span in which cam peaks of the first cam part under strong spring tension are pressingly pivoting over cam peaks of the second cam part. The point loads, which are occurring then, cause the cam parts to wear out rather rapidly. In general, this wear and tear worsens the larger and/or the heavier the trunnion doors are, since for larger and/or heavier trunnion doors the spring element in general is more strongly pre-tensioned, in view of the larger mass moments of inertia occurring during the hinging of larger and/or heavier trunnion doors.

With an eye to the application to larger and/or heavier trunnion doors, NL 2002119 also discusses a variant (see FIG. 4 of NL 2002119), in which apart from a first cam part 111 and a second cam part 112 (similar to the cam parts 11 and 12 of FIG. 2 of NL 2002119), an additional cam part 114 at the other end of the first cam part 111 is applied. This additional cam part 114 is similar to the second cam part 112 in the sense that the cam part 114 just like the cam part 112 is nonpivotable relative to the second hinge part. Furthermore, the cam part 111 also has additional cams at its end facing the additional cam element 114, which additional cams co-operate with the cams of the additional cam part 114. Thereby the pressing forces are distributed over larger surfaces. However, for the trunnion door hinge known from FIG. 4 of NL 2002119 said point loads still occur for all cam parts, since still cam peaks are pressingly pivoting over one another under strong spring tension. This still leads to relatively rapid wear and tear of the cam parts.

A second drawback of the trunnion door hinges known from NL 2002119 has to do with the user-friendliness of the mounted trunnion door hinges. This is explained as follows. The closed door is in the so-called “0 degrees preferential position”. If the user swings the closed trunnion door open over a range up to 45 degrees, passes the doorway, and subsequently releases the door, the trunnion door automatically returns in the direction of the 0 degrees preferential position. Next, around the 0 degrees preferential position a number of inconvenient reciprocating swinging movements of the trunnion door occur. And if the user swings the closed trunnion door open over a range of more than 45 degrees, passes the doorway, and subsequently releases the door, the door automatically, but often unintended by the user, moves in the direction of the 90 degrees preferential position. Also around the 90 degrees preferential position a number of inconvenient reciprocating swinging movements of the trunnion door occur. Such kinds of behavior of trunnion doors provided with trunnion door hinges known from NL 2002119 usually are experienced by users as undesirable. Users appear to prefer other kinds of behavior of the trunnion door.

Rather a user would like to have a situation in which the user can, after he has swung the trunnion door out of the 0 degrees preferential position, swing the trunnion door with relatively little force over a larger range of about 60 to about 80 degrees, whereafter the trunnion door upon releasing thereof automatically returns in the direction of the 0 degrees preferential position, and wherein reciprocating swinging movements around the 0 degrees preferential position are performed to a lesser extent. In case the user wishes to purposefully position the door in the 90 degrees preferential position, the user considers it desirable that he can then purposefully push the trunnion door, being opened over about 60 to about 80 degrees, with some extra force in the direction of the 90 degrees preferential position. Preferably, also around said 90 degrees preferential position the door will less intensively swing to and fro. The required extra force to purposefully push the trunnion from the about 60 to about 80 degrees range in the direction of the 90 degrees preferential position, is also considered desirable by users for the reason that thereby it is prevented that a trunnion door, which by accident is pushed open very forcefully, will be smashed very hard in the 90 graden degrees preferential position, whereby the trunnion door and/or the trunnion door hinge may experience damage.

### SUMMARY OF THE INVENTION

It is an object of the present invention to provide a trunnion door hinge, which is less susceptible to wear and tear.

For that purpose, the invention provides a trunnion door hinge for hingeably interconnecting a trunnion door and a horizontal boundary, situated near to the door, of the doorway, comprising: a hinge shaft; a first hinge part designed for interconnecting the trunnion door hinge and the horizontal boundary; a second hinge part designed for interconnecting the trunnion door hinge and a lower side or an upper side of the trunnion door, wherein the second hinge part, in the sense of the hinge line of the hinge shaft, is hingeable relative to the first hinge part; and a cam mechanism, comprising a first cam part, a second cam part and at least one first spring element, wherein the first cam part and the second cam part are separately lying in line along the hinge line, and wherein the at least one first spring element is pre-tensioned to bias the first cam part and the second cam part towards one another along the hinge line; wherein the first cam part comprises at least two first cams at its end, in the sense of the hinge line, facing the second cam part, and the second cam part comprises at least two second cams at its end, in the sense of the hinge line, facing the first cam part; and wherein, during said hinging, the first cam part, in the sense of the hinge line, is nonpivotable relative to the first hinge part, and the second cam part, in the sense of the hinge line, is nonpivotable relative to the second hinge part; wherein the cam mechanism further comprises a third cam part, wherein: the third cam part is situated in-between the first cam part and the second cam part; the third cam part comprises at least two third cams at its end, in the sense of the hinge line, facing the first cam part, which third cams interlock with the first cams of the first cam part, and the third cam part comprises at least two fourth cams at its end, in the sense of the hinge line, facing the second cam part, which fourth cams interlock with the second cams of the second cam part; and during said hinging, the third cam part, in the sense of the hinge line, is helically pivotable relative to the first cam part in a first pivot range, and, in the sense of the hinge line, is helically pivotable relative to the second cam part in a second pivot range.

Thus, for the trunnion door hinge according to the invention the first cam part, which is nonpivotable relative to the first hinge part, does not interlock directly with the second cam part, which is nonpivotable relative to the second hinge part, but the third cam part is situated in-between the first cam part and the second cam part. For the thus stepped mechanism of cam parts, as a consequence of succession of said first pivot range and said second pivot range, the mutual pivot range between the first cam part and the second cam part can be expanded without situations needing to occur in which cam peaks pivot over cam peaks. Because of this, point loads are prevented, which counteracts wear and tear of cam parts.

In a preferable embodiment, a first preferential hinging position of the trunnion door hinge corresponds to the mutual position of the first cam part and the second cam part, in which the first cam part and the second cam part are biased most closely towards one another by the at least one first spring element. When hinging out of this first preferential hinging position, the third cam part initially remains automatically nonpivotable relative to that one of the first cam part and the second cam part with which the third cam part has the largest resistance against said helical pivotability. Hence, the third cam part initially automatically pivots along with that cam part concerned in the corresponding one of the first pivot range and the second pivot range. Next, the third cam part can pivotingly move along with the other of the first cam part and the second cam part in the other of the first pivot range and the second pivot range. This has the consequence that the pivoting resistance for pivoting out of the first preferential hinging position initially is automatically the lowest, and next, after transition from the one into the other pivot range, becomes higher. Thereby more user-friendly kinds of behavior of a trunnion door provided with the trunnion door hinge are obtained.

Said first preferential hinging position may for example correspond to a closed position of the trunnion door (the so-called “0 degrees preferential position”), while a second preferential position of the trunnion door hinge differs by 90 degrees from this 0 degrees preferential position. In that case a user can, after he has pushed the trunnion door out of the 0 degrees preferential position, push open the trunnion door over a large range with relatively little force. To purposefully bring the door in the 90 degrees preferential position, the user can subsequently purposefully push the door with a bit more force in the direction of the 90 degrees preferential position.

The resistance against said helical pivotability of the third cam part relative to the first cam part may differ from the resistance against said helical pivotability of the third cam part relative to the second cam part, by means of differences in the choices of the geometry and/or materials of the third cams and/or of the first cams interlocking therewith, versus the geometry and/or materials of the fourth cams and/or of the second cams interlocking therewith. As regards differences in geometry, it is amongst others possible to apply differences in contact surface areas and/or in helical pitch angles of the cam parts. And as regards differences in materials, it is amongst others possible to apply differences in kinds of materials and/or in finishings of contact surfaces between the cam parts.

In a further preferable embodiment, the third cam part and/or the first cam part interlocking therewith comprise(s) first stop means, which first stop means is designed to limit the first pivot range. With such first stop means certain hinging characteristics of the trunnion door hinge can be adjusted as desired.

In a further preferable embodiment, the third cam part and/or the second cam part interlocking therewith comprise(s) second stop means, which second stop means is designed to limit the second pivot range. Also with such second stop means certain hinging characteristics of the trunnion door hinge can be adjusted as desired.

In a further preferable embodiment, the trunnion door hinge further comprises a preferred positions mechanism which defines at least one preferential hinging position of the trunnion door hinge, wherein the preferred positions mechanism comprises respective first interlocking means of the first hinge part and second interlocking means of the second hinge art, which under second spring force of at least one second spring element can interlock close-fittingly with one another for realizing a preferential hinging position concerned of the at least one preferential hinging position of the trunnion door hinge, in which preferential hinging position concerned the first interlocking means and the second interlocking means under said second spring force interlock close-fittingly with one another, such that during the hinging of the trunnion door hinge into and out of the preferential hinging position concerned the interlocking first and second interlocking means under said spring force move relative to one another with at least a movement component in a direction transverse to the hinge line.

Therefore, for such a preferred positions mechanism the at least one preferential hinging position is not determined by interlockings of cams of the cam mechanism. This offers more design freedom for the design of the cam mechanism, whereby the cam mechanism can more far-goingly be directed to counteracting wear and tear of the cam mechanism and to user-friendliness of the trunnion doors.

Preferably, the at least one preferential hinging position defined by the preferred positions mechanism comprises a preferential hinging position, which corresponds to the mutual position of the first cam part and the second cam part, in which the first cam part and the second cam part are biased most closely towards one another by the at least one first spring element. This improves the stability of this first preferential hinging position, whereby in this first preferential hinging position the reciprocating swinging of the trunnion door is reduced. Thus, when for example said first preferential hinging position corresponds to a closed position of the trunnion door (the so-called “0 degrees preferential position”), as mentioned above, the reciprocating swinging of the trunnion door in the 0 degrees preferential position is reduced.

In a further preferable embodiment, the trunnion door hinge further comprises a braking mechanism for the slowing down of said hinging, wherein the braking mechanism comprises a brake shoe, which is working under third spring force of at least one third spring element, wherein the press-on force of the brake shoe is directed in a direction transverse to the hinge line. Such a braking mechanism offers additional design possibilities and design freedoms for the realization of trunnion doors with improved user-friendliness.

Preferably, the braking mechanism provides a braking force which is variable in dependence of the relative hinge angle between the first hinge part and the second hinge part. This may for example be realized by letting the brake shoe act upon an outer surface, being noncylindrically formed around the hinge line, of a part of the trunnion door hinge, which part is nonpivotably fixed relative to the first hinge part. Such a variability offers yet further design possibilities and design freedoms for the realization of trunnion doors with improved user-friendliness. By means of such a variability it is for example possible to improve the stability of one or more preferential hinging positions to reduce the reciprocating swinging of the trunnion door in that one or more preferential hinging positions.

The invention furthermore is embodied in a trunnion door provided with at least one trunnion door hinge according to any one of the above described embodiments of the invention.

### BRIEF DESCRIPTION OF THE DRAWINGS

In the following, the invention is further elucidated with reference to the schematic Figures in the attached drawing.

FIG. 1 shows in front view an example of a trunnion door in closed position, which trunnion door is provided with two trunnion door hinges according to an example of an embodiment of the invention.

FIG. 2 shows, in perspective view and in disassembled condition, one of the two trunnion door hinges shown in FIG. 1. FIG. 3 shows, in side view, the trunnion door hinge of FIG. 2 in an assembled condition.

FIG. 4 shows the trunnion door hinge of FIG. 3 in view from above.

FIG. 5 shows the trunnion door hinge in a longitudinal cross-section taken along the plane pointed at by arrows V in FIG. 4, wherein the longitudinal cross-section is viewed at in the direction of the arrows V.

FIG. 6 shows the trunnion door hinge in a transverse cross-section taken along the plane pointed at by arrows VI in FIG. 3, wherein the transverse cross-section is viewed at in the direction of the arrows VI.

FIG. 7 shows, in perspective and enlarged view, the first cam part of the trunnion door hinge shown in FIG. 2.

FIG. 8 shows, in perspective and enlarged view, the third cam part of the trunnion door hinge shown in FIG. 2.

FIG. 9 shows, in perspective and enlarged view, the second cam part of the trunnion door hinge shown in FIG. 2.

FIG. 10 shows a perspective view of the first, second and third cam parts, when assembled relative to one another, and in a first hinging condition of the trunnion door hinge, which first hinging condition corresponds to the hinging condition of the trunnion door hinge shown in FIGS. 1, 5 and 6.

FIG. 11 shows the situation of FIG. 10 again, however, in a second hinging condition of the trunnion door hinge, which second hinging condition has been obtained after the trunnion door hinge has hinged out of the first hinging condition over a first pivot range in a first hinge direction.

FIG. 12 shows the situation of FIGS. 10 and 11 again, however, in a third hinging condition of the trunnion door hinge, which third hinging condition has been obtained after the trunnion door hinge has further hinged out of the second hinging condition of FIG. 11 over a second pivot range in the same, said first hinge direction.

### DETAILED DESCRIPTION OF THE INVENTION

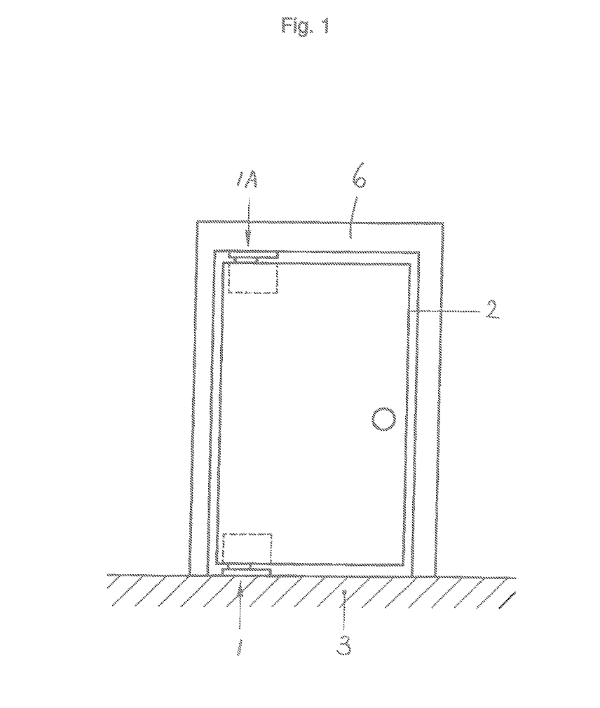

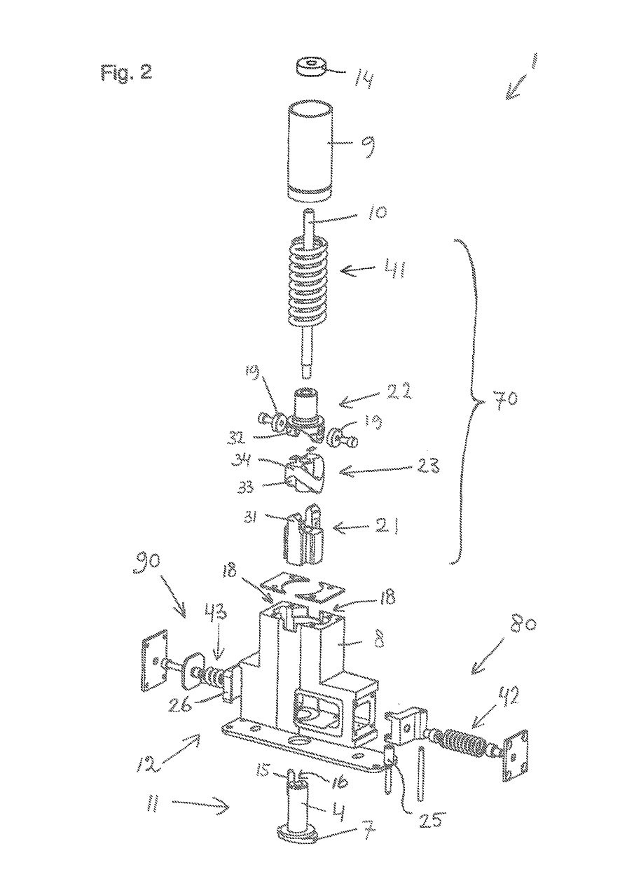

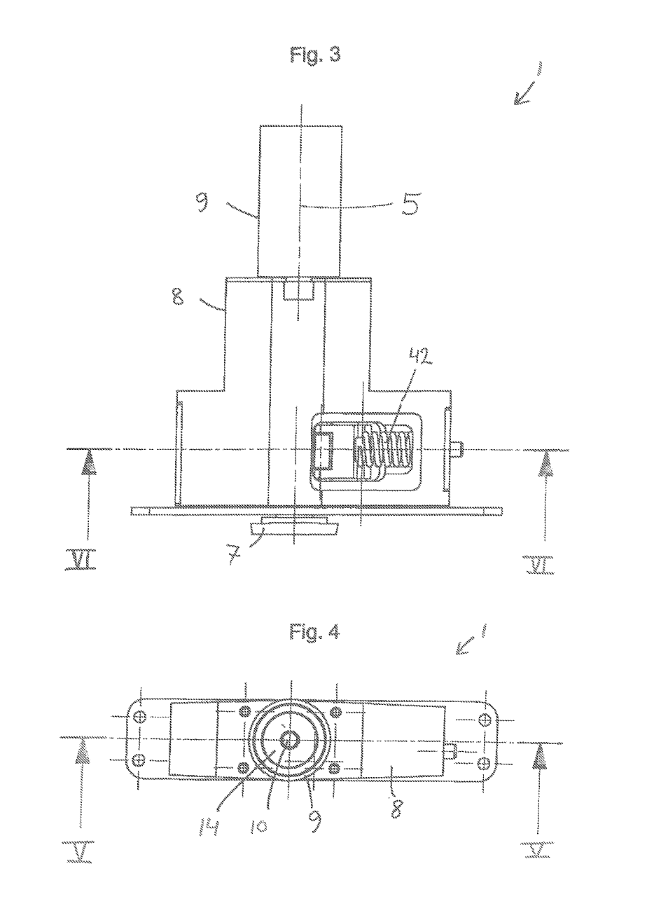

FIG. 1 shows a trunnion door 2 and, near to the door, a boundary of the doorway. The horizontal parts of said boundary are shown in the form of a floor 3 and an upper part 6 of a door frame. The trunnion door 2 is provided with two similar trunnion door hinges 1 and 1A according to the invention, the lower trunnion door hinge 1 of which is shown in greater detail in FIGS. 2-12. It is remarked that the trunnion door instead of two trunnion door hinges according to the invention may also have only one such trunnion door hinge, for example only at the bottom side or only at the top side of the trunnion door. The other hinge may then be of another type.

In FIG. 2 a number of parts and aspects of the shown trunnion door hinge according to the invention are indicated by reference numerals. The trunnion door hinge is indicated by reference numeral 1, the hinge shaft by No. 4, the first hinge part by No. 11, the second hinge part by No. 12, and the cam mechanism by No. 70. Of the cam mechanism 70 the first spring element is indicated by No. 41, the first cam part by No. 21, the second cam part by No. 22, and the third cam part by No. 23. The first cams of the first cam part 21 are indicated by No. 31, the second cams of the second cam part 22 by No. 32, the third cams of the third cam part 23 by No. 33, and the fourth cams of the third cam part 23 by No. 34. In the example, the number of the first, second, third and fourth cams each time is two.

In the shown example, the first hinge part 11 comprises a floor plate 7, as well as the hinge shaft 4. The hinge shaft 4 is firmly fixed to the floor plate 7 or is, for example, integrally manufactured therewithof. In FIG. 3 the hinge line of the hinge shaft is indicated by reference numeral 5.

Apart from the floor plate 7 and the lower part of the hinge shaft 4, all other parts, shown in FIG. 2, of the trunnion door hinge 1 are meant to be received into a recess of the door, as schematically shown in FIG. 1 by broken lines.

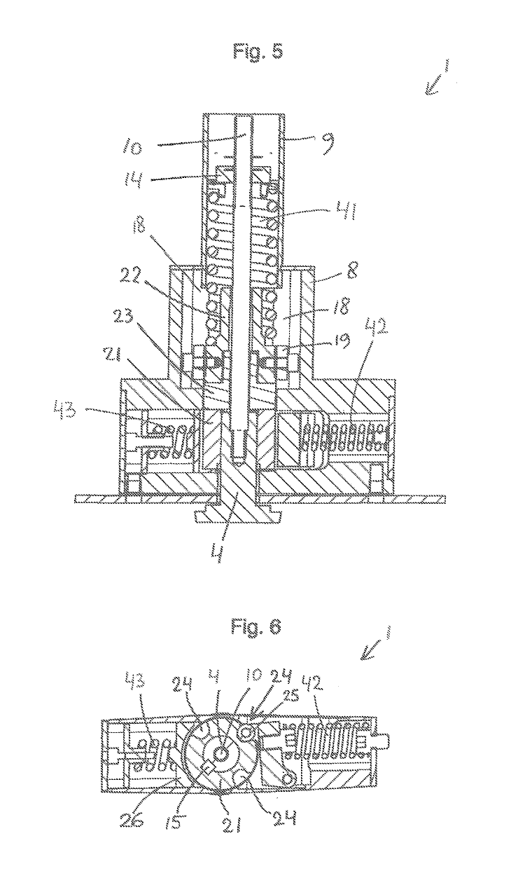

In the shown example a long threaded bolt 10 with its lower end is firmly screwed down into the hinge shaft 4, while near its upper end a nut 14 is screwed down onto the threaded bolt 10 (also see FIG. 5). The second hinge part 12 comprises housing parts 8 and 9, which are bearing-mountedly hingeable around the hinge line 5 relative to the construction consisting of the hinge shaft 4, the threaded bolt 10 and the nut 14. In that respect, the upper housing part 9 is bearing-mountedly hingeable relative to the nut 14, and the lower housing part 8 is bearing-mountedly hingeable relative to the hinge shaft 4.

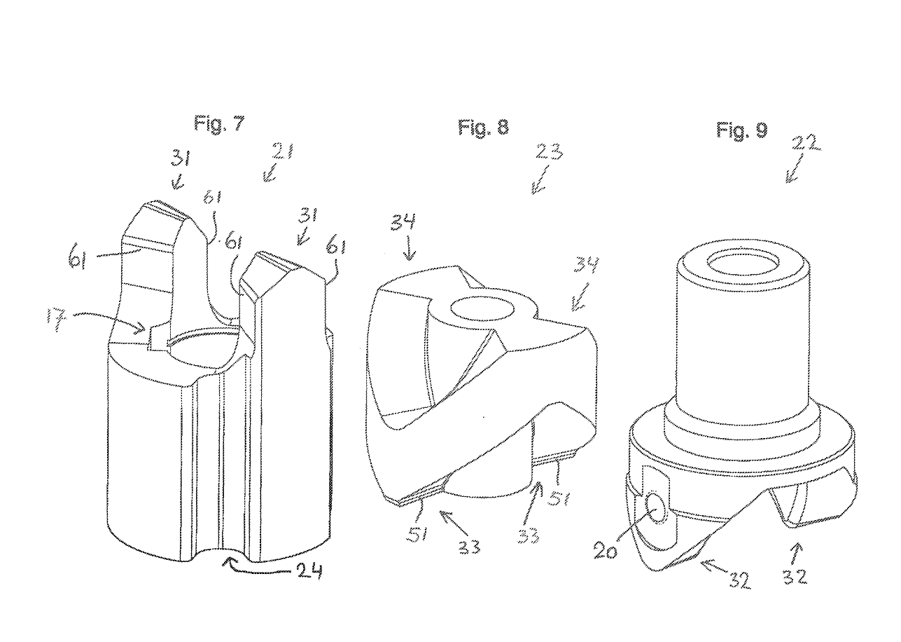

The hinge shaft 4 has a key groove 16 (see FIG. 2), and the first cam part 21 has a key groove 17 (see FIG. 7). By means of a key 15 mounted in these key grooves 16 and 17 (see FIGS. 2 and 6), the first cam part 21 is nonpivotably mounted relative to the hinge shaft 4.

The housing part 8 has two guide grooves 18 (see FIGS. 2 and 5), and within two threaded openings 20 of the second cam part 22 (see FIG. 9) two shafts are screwed down, which shafts are holding two guide wheels 19 on opposite sides of the second cam part 22 (see FIGS. 2 and 5). Since the guide wheels 19 are received in the two guide grooves 18, the second cam part 22 is mounted relative to the housing part 8 in a nonpivotable manner around the hinge line 5, while the second cam part 22 to a certain extent is reciprocatingly movable parallel to the hinge line 5.

The third cam part 23 (see FIG. 8), situated in-between the first cam part 21 and the second cam part 22, does not have such a key connection with the first hinge part 11 and also does not have such guide groove connections with the second hinge part 12. The third cam part 23 in fact is prevented neither by the first hinge part 11 nor by the second hinge part 12 to reciprocatingly rotate around the hinge line 5 to a certain extent. Furthermore, the third cam part 23 to a certain extent is reciprocatingly movable parallel to the hinge line 5.

The first cam part 21 further has a number of grooves 24 (see FIGS. 6 and 7) at its outer circumference, which grooves 24 extend parallel to the hinge line 5. These grooves 24 act as the first interlocking means, introductorily described above, of the preferred positions mechanism 80 (see FIG. 2), introductorily described above, of the trunnion door hinge 1. The second interlocking means, introductorily described above, of the preferred positions mechanism are formed by a guide roll 25 (see FIGS. 2 and 6). Under spring force of the shown second spring element 42, the guide roll 25 is able to roll around the outer circumference of the first cam part 21, and also is able to close-fittingly interlock with each of the grooves 24. In the example, the first cam part 21 has three such grooves 24. The groove 24, shown in FIG. 6, with which the guide roll 25 interlocks, corresponds to the “0 degrees preferential position”, introductorily described above, of the trunnion door hinge, corresponding to the closed position of the trunnion door 2, which closed position is shown in FIG. 1. The other two grooves 24 shown in FIG. 6 define preferential positions of +90 degrees and −90 degrees relative to said 0 degrees preferential position.

In the shown example, the trunnion door hinge 1 further comprises a braking mechanism 90 (see FIG. 2) of the type as introductorily described above. In the shown example, the at least one third spring element, introductorily described above, is formed by the third spring element 43 shown in FIGS. 2 and 6, while the brake shoe, introductorily described above, is formed by the brake shoe 26 shown in FIGS. 2 and 6.

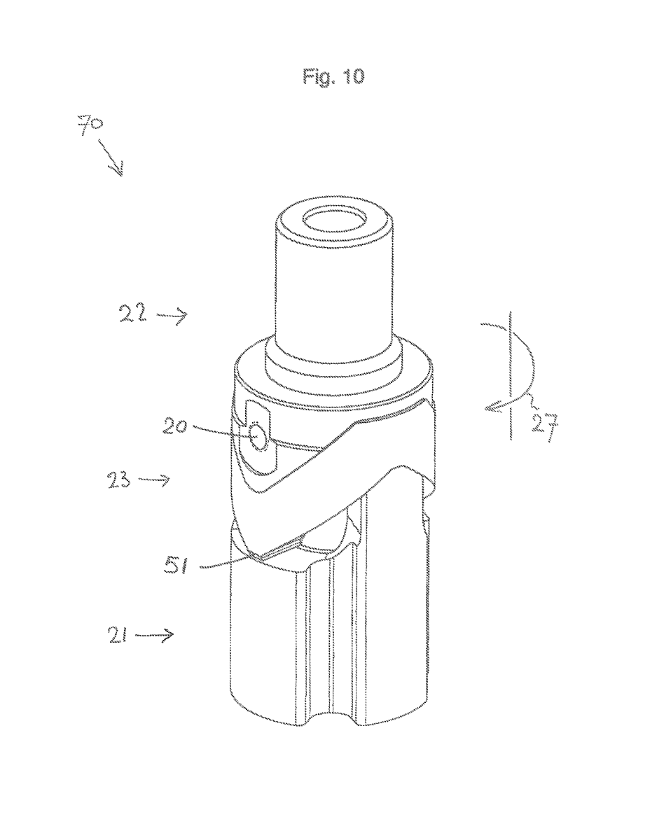

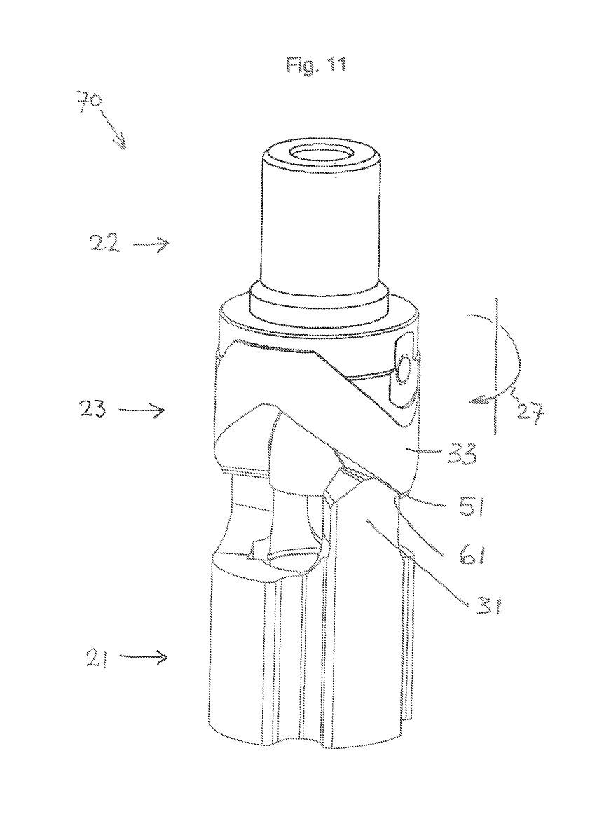

Reference is now made to FIG. 10. Therein, the first, second and third cam parts are shown in a first hinging condition in which the first cam part 21 and the second cam part 22 are biased most closely towards one another by the first spring element 41. Thereby, that first hinging condition is a preferential hinging condition of the trunnion door hinge 1. After all, the pre-tensioned first spring element 41 will, under circumstances, press the first cam part 21 and the second cam part 22 as close as possible towards one another. Moreover, in the shown example, the trunnion door hinge is designed in such manner that this mutual position, of being most closely biased towards one another, also corresponds to a preferential hinging position defined by the preferred positions mechanism 80, more in particular the abovementioned 0 degrees preferential position, which corresponds to the closed position, shown in FIG. 1, of the trunnion door 2.

FIG. 11 shows the situation of FIG. 10 again, however, in a second hinging condition of the trunnion door hinge. Starting off from the situation of FIG. 10, this second hinging condition is obtained in that the second cam part 22, which is fixed against rotation relative to the second hinge part 12, has rotated in the direction of the shown arrow 27 relative to the first cam part 21, which is fixed against rotation relative to the first hinge part 11. During said rotation, in this example, the third cam part 23 has automatically been taken along in said rotation by the second cam part 22, since in this example the third cam part 23 relative to the second cam part 22 has a larger resistance against the helical pivotability than it has relative to the first cam part 21. In FIG. 11 it is seen that in FIG. 11 it has been rotated until stops 51, provided at the third cams 33 of the third cam part 23, have touched stops 61, provided at the first cams 31 of the first cam part 21.

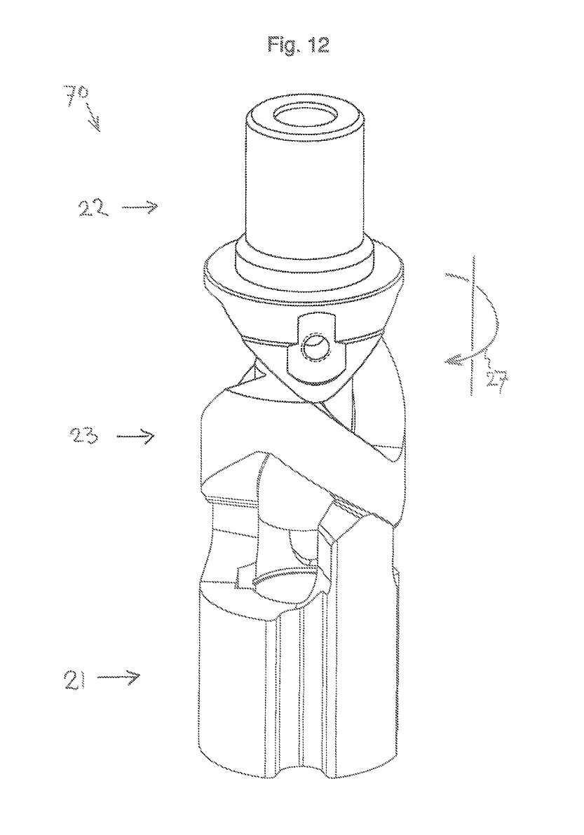

FIG. 12 shows the situation of FIGS. 10 and 11 again, however, in a third hinging condition of the trunnion door hinge, which third hinging condition is obtained in that the second cam part 22, from the condition of FIG. 11 has further rotated in the direction of the arrow 27 relative to the first cam part 21. As a consequence of the stops 51 and 61 lying against each other, the third cam part 33 now has not farther rotated relative to the first cam part 21, which means that the third cam part 33 has now rotated relative to the second cam part 22. It is remarked that in the transfer from the first hinging condition to the third hinging condition, as shown in the example of the FIGS. 10, 11 and 12, the second cam part 22 has rotated in total over more than 90 degrees relative to the first cam part 21. This means that the trunnion door hinge 1 from the 0 degrees preferential position of FIG. 10 has rotated farther than a 90 degrees preferential position. If desired, it is possible to provide at the third cam part 23 and/or at the second cam part 22, interlocking therewith, second stop means, which second stop means are designed to limit the total hinge range of the trunnion door hinge 1.

In this example, the shown cam parts 21, 22 and 23 are symmetrical in such manner that, if from the situation of FIG. 10 there would be rotated in a direction opposite to the shown arrow 27, the same effects would occur as described above in connection with FIGS. 10, 11 and 12.

It is remarked that the abovementioned embodiment does not limit the invention, and that various alternatives are possible within the scope of the appended claims.

In the present document, for example, helical pivotability of cam parts has been described. For reasons of clarity, it is remarked here that in the present document helical pivotability of a cam part, in the sense of the hinge line, means simultaneous rotation and translation of the cam part, wherein the rotation takes place around the hinge line, and wherein the translation takes place in a direction parallel to the hinge line. During the helical pivoting the ratio between the velocity of said rotation and the velocity of said translation, as seen in the course of time, may be constant or variable, wherein “variable” may also mean “partly constant”, and wherein “partly constant” may also mean “partly zero” or “partly infinite”. In that sense the invention comprises various embodiments of trunnion door hinges, wherein the first cam part, the second cam part and the third cam part are designed in various manners such that said ratios for the helical pivotabilities of the third cam part relative to the first cam part and of the third cam part relative to the second cam part may have various constant values or may be variable in various ways.

Furthermore, in the shown example, the third cam part is a single part. Instead of that, it is however also possible to design the third cam part in two or more parts, that is two or more cam parts, which interlock relative to one another in a similar manner as how in the shown example the third cam part interlocks with the first cam part or with the second cam part. Thus, the cam mechanism may be designed in a more fargoing stepped manner that in the shown example. By applying such more fargoing stepped cam mechanisms, the first pivot range and the second pivot range can thus be supplemented by one or more additional such pivot ranges.

Furthermore, in the shown example, the cam mechanism, the preferred positions mechanism and the braking mechanism are received in a door recess of the trunnion door. However, it is also possible to locate the cam mechanism and/or the preferred positions mechanism and/or the braking mechanism fully or partly in a recess in the horizontal boundary (for example in a pit in the floor), or partly at a side of the trunnion door.

Furthermore, in the shown example the shown first, second and third spring elements each time are helical springs. Of course, instead of helical spring elements various other kinds of spring elements can be apphed. If desired, the trunnion door hinge can be provided with adjustment means for adjusting the pre-tensioning of the spring elements applied in the trunnion door hinge. Preferably, the adjustment means of one, more or all of the spring elements applied in the trunnion door hinge are also actuatable when the trunnion door hinge is already mounted in a door. More preferably, the adjustment means of one more or all of the spring elements applied in the trunnion door hinge are also actuatable when the trunnion door together with the mounted trunnion door hinge is placed in its operation condition. In the shown example the third spring element 43 can for example be actuatably adjustable when the trunnion door together with the mounted trunnion door hinge is placed in its operation condition, while the first spring element 41 and/or the second spring element 42 are for example not actuatably adjustable in said placed operation condition of the trunnion door. In this manner the first spring element 41 and/or the second spring element 42 may be adjusted in the factory, while the third spring element 43 can be adjusted by an operator when the trunnion door is mounted. Because of this, the reliable factory settings are guaranteed for long time, while maintaining a simple and efficiently executable fine-adjustment possibility by means of the in situ adjustment of the third spring element.

All parts of the trunnion door hinge according to the invention can of course be manufactured from various kinds of materials.

However, other variations or modifications are also possible. These and similar alternatives are deemed to fall within the scope of the invention as defined in the appended claims.

What is claimed is:

1. A trunnion door hinge for hingeably interconnecting a trunnion door and a horizontal boundary, situated near to the door, of the doorway, comprising:
a hinge shaft;
a first hinge part designed for interconnecting the trunnion door hinge and the horizontal boundary;
a second hinge part designed for interconnecting the trunnion door hinge and a lower side or an upper side of the trunnion door, wherein the second hinge part, in the sense of a hinge line of the hinge shaft, is hingeable relative to the first hinge part; and
a cam mechanism, comprising a first cam part, a second cam part and at least one first spring element, wherein the first cam part and the second cam part are separately lying in line along the hinge line, and wherein the at least one first spring element is pre-tensioned to bias the first cam part and the second cam part towards one another along the hinge line;
wherein the first cam part comprises at least two first cams at its end, in the sense of the hinge line, facing the second cam part, and the second cam part comprises at least two second cams at its end, in the sense of the hinge line, facing the first cam part;
wherein, during said hinging, the first cam part, in the sense of the hinge line, is nonpivotable relative to the first hinge part, and the second cam part, in the sense of the hinge line, is nonpivotable relative to the second hinge part;
wherein the cam mechanism further comprises a third cam part, wherein:
the third cam part is situated in-between the first cam part and the second cam part;
the third cam part comprises at least two third cams at its end, in the sense of the hinge line, facing the first cam part, which third cams interlock with the first cams of the first cam part, and the third cam part comprises at least two fourth cams at its end, in the sense of the hinge line, facing the second cam part, which fourth cams interlock with the second cams of the second cam part; and
during said hinging, the third cam part (23), in the sense of the hinge line, is helically pivotable relative to the first cam part (21) in a first pivot range, and, in the sense of the hinge line, is helically pivotable relative to the second cam part (22) in a second pivot range.

2. The trunnion door hinge according to claim 1, wherein a first preferential hinging position of the trunnion door hinge corresponds to a mutual position of the first cam part and the second cam part, in which the first cam part and the second cam part are biased most closely towards one another by the at least one first spring element.

3. The trunnion door hinge according to claim 1, wherein geometry and/or materials of the third cams and/or of the first cams interlocking therewith, differ(s) relative to geometry and/or materials of the fourth cams and/or of the second cams interlocking therewith, in such manner that resistance against said helical pivotability of the third cam part relative to the first cam part differs from resistance against said helical pivotability of the third cam part relative to the second cam part.

4. The trunnion door hinge according to claim 1, wherein the third cam part and/or the first cam part interlocking therewith comprise(s) first stop means, which first stop means is designed to limit the first pivot range.

5. The trunnion door hinge according to claim 1, wherein the third cam part and/or the second cam part interlocking therewith comprise(s) second stop means, which second stop means is designed to limit the second pivot range.

6. The trunnion door hinge according to claim 1, further comprising a preferred positions mechanism which defines at least one preferential hinging position of the trunnion door hinge, wherein the preferred positions mechanism comprises respective first interlocking means of the first hinge part and second interlocking means of the second hinge part, which under second spring force of at least one second spring element can interlock close-fittingly with one another for realizing a preferential hinging position concerned of the at least one preferential hinging position of the trunnion door hinge, in which preferential hinging position concerned the first interlocking means and the second interlocking means under said second spring force interlock close-fittingly with one another, such that during the hinging of the trunnion door hinge into and out of the preferential hinging position concerned the interlocking first and second interlocking means under said spring force move relative to one another with at least a movement component in a direction transverse to the hinge line.

7. The trunnion door hinge according to claim 6, wherein the at least one preferential hinging position defined by the preferred positions mechanism comprises a preferential hinging position, which corresponds to the mutual position of the first cam part and the second cam part, in which the first cam part and the second cam part are biased most closely towards one another by the at least one first spring element.

8. The trunnion door hinge according to claim 1, further comprising a braking mechanism for the slowing down of said hinging, wherein the braking mechanism comprises a brake shoe, which is working under third spring force of at least one third spring element, wherein the press-on force of the brake shoe is directed in a direction transverse to the hinge line.

9. The trunnion door hinge according to claim 8, wherein the braking mechanism provides a braking force which is variable in dependence of the relative hinge angle between the first hinge part and the second hinge part.

10. The trunnion door provided with at least one trunnion door hinge according to claim 1.

11. The trunnion door according to claim 10, wherein a first preferential hinging position of the trunnion door hinge corresponds to a mutual position of the first cam part and the second cam part, in which the first cam part and the second cam part are biased most closely towards one another by the at least one first spring element, and wherein said first preferential hinging position corresponds to a closed position of the trunnion door.

12. The trunnion door according to claim 2, wherein geometry and/or materials of the third cams and/or of the first cams interlocking therewith, differ(s) relative to geometry and/or materials of the fourth cams and/or of the second cams interlocking therewith, in such manner that resistance against said helical pivotability of the third cam part relative to the first cam part differs from resistance against said helical pivotability of the third cam part relative to the second cam part.

13. The trunnion door according to claim 12, wherein the third cam part and/or the first cam part interlocking therewith comprise(s) first stop means, which first stop means is designed to limit the first pivot range.

14. The trunnion door according to claim 13, wherein the third cam part and/or the second cam part interlocking therewith comprise(s) second stop means, which second stop means is designed to limit the second pivot range.

15. The trunnion door according to claim 14, further comprising a preferred positions mechanism which defines at least one preferential hinging position of the trunnion door hinge, wherein the preferred positions mechanism comprises respective first interlocking means of the first hinge part and second interlocking means of the second hinge part, which under second spring force of at least one second spring element can interlock close-fittingly with one another for realizing a preferential hinging position concerned of the at least one preferential hinging position of the trunnion door hinge, in which preferential hinging position concerned the first interlocking means and the second interlocking means under said second spring force interlock close-fittingly with one another, such that during the hinging of the trunnion door hinge into and out of the preferential hinging position concerned the interlocking first and second interlocking means under said spring force move relative to one another with at least a movement component in a direction transverse to the hinge line.

16. The trunnion door according to claim 15, wherein the at least one preferential hinging position defined by the preferred positions mechanism comprises a preferential hinging position, which corresponds to the mutual position of the first cam part and the second cam part, in which the first cam part and the second cam part are biased most closely towards one another by the at least one first spring element.

17. The trunnion door according to claim 16, further comprising a braking mechanism for the slowing down of said hinging, wherein the braking mechanism comprises a brake shoe, which is working under third spring force of at least one third spring element, wherein the press-on force of the brake shoe is directed in a direction transverse to the hinge line.

18. The trunnion door according to claim 17, wherein the braking mechanism provides a braking force which is variable in dependence of the relative hinge angle between the first hinge part and the second hinge part.

19. A trunnion door provided with at least one trunnion door hinge according to claim 18.

20. The trunnion door according to claim 19, wherein a first preferential hinging position of the trunnion door hinge corresponds to a mutual position of the first cam part and the second cam part, in which the first cam part and the second cam part are biased most closely towards one another by the at least one first spring element, and wherein said first preferential hinging position corresponds to a closed position of the trunnion door
